(19) United States
(12) Patent Application Publication
(10) Pub. No.: US 2005/0182738 A1
(43) Pub. Date: Aug. 18, 2005

(54) Message handling device and method for telecommunication terminal and telecommunication terminal provided with such a device

(76) Inventors: Denis Prouvost, Paris (FR); Arnaud Brun, Boulogne Billancourt (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/961,467

(22) Filed: Oct. 8, 2004

(30) Foreign Application Priority Data
Oct. 10, 2003 (FR) FR 0311905

(51) Int. Cl. G06N 5/02

(52) U.S. Cl. 706/46; 713/201

(57) ABSTRACT

This message-handling device for telecommunication terminal is intended for the analysis of messages received during the use of an electronic messaging service. It includes a message analyser suitable for detecting a message type amongst a set of predetermined message types capable of transporting data intended for software applications onboard the terminal and data extraction means suitable for extracting, from each received message that belongs to one of the said message types, the data intended for the said applications.

### BACKGROUND OF THE INVENTION

1. Field of the Invention

The present invention relates to a message handling device and method for telecommunication terminal and relates in particular to the handling of messages received by a telecommunication terminal during the use of an electronic messaging service. The invention also relates to a telecommunication terminal equipped with such a handling device.

2. Description of the Relevant Art

Electronic messaging services are currently used for transmitting to a remote terminal messages which are presented in the form of a text associated, where appropriate, with sound, with still images, with moving images, even with video.

Thus, for example, the short message service or SMS is used to send to a terminal of a remote user a text coded for example on seven bits, which corresponds to 160 characters. This service is used to send several classes of SMS messages which correspond to various modes of handling messages by the terminal.

Class zero is for sending a message which, when it is received, is directly displayed on the screen of the remote terminal without being stored in its memory.

Class 1 corresponds to a mode of use according to which the message, when it is received, is stored in the memory of the terminal or in the SIM card identification module of the subscriber. The user is usually notified of the receipt of such a message by display of an icon on the terminal screen. After consultation, the message may be either erased, or retained in memory for a subsequent consultation. Finally, class 2 is used for sending to the terminal a service message which is intended for the SIM card of the subscriber and is used, for example, for updating SIM card files, triggering particular SIM card software, etc.

According to the latter operating mode, the terminal is provided with an algorithm for detecting the type of message received in order to identify the messages belonging to class 2 in order to send them directly to the SIM card.

The EMS messaging service (“Enhanced Messaging Service”) is an evolution of the abovementioned SMS messaging service and is used to send formatted text, sound, still images or moving images to the final recipient. At the remote terminal, the EMS messages are detected as such and handled accordingly. The terminal of the user therefore carries out a detection of the EMS messages in order to carry out a particular processing of those messages.

The MMS messaging service (“Multimedia Messaging Service”) is a service which allows the remote users to send or receive large size multimedia messages, that is to say messages whose content may be text, images, sound and video. This service requires the use of an MMS server in which the messages are stored then retrieved automatically or at the request of the user.

Finally, the electronic mail service is a relatively powerful messaging service which is used for sending or receiving a large size multimedia message which may contain text, images, sound, video data, etc.

These various electronic messaging services are used to transmit data of varying types relatively effectively to remote subscribers. They do however have a major drawback in that, through these messaging services, it is not possible to manage in generic manner the reception of data intended for software applications onboard the terminal.

These services also require the use of a specific terminal compatible with these services.

### SUMMARY OF THE INVENTION

Described herein is a message-handling device for a telecommunication terminal according to which the messages are received by the terminal during the use of an electronic messaging service. This device includes a message analyser suitable for detecting one type of message amongst a set of predetermined message types capable of transporting data intended for software applications onboard the terminal and data extraction means suitable for extracting, from each received message that belongs to one of the message types, the data intended for the applications.

Thus, after extraction, the data may be presented as an input of programs internal to the terminal.

According to another embodiment of the device, the device also includes means of storing the data extracted from the messages by the extraction means.

In one embodiment, the message analyser includes memorization means in which is stored, for each message type of the said set of message types, a set of at least one selection criterion intended to be applied to each message received by the terminal for the detection of the message type.

As a variant, the received messages being written in extensible markup language, XML, the message analyser includes an XML syntax analyser.

According to another embodiment, the data extraction means include memorization means in which is stored, for each message type, a set of at least one data identifier intended to recognize the type of data transported by the message, each data identifier being assigned a corresponding data extraction method.

According to another embodiment, the data storage means includes, for each extracted data item identified by a data type, data type and data value information.

According to another embodiment, a further proposal is for a telephone terminal that it is equipped with a message-handling device as defined above.

Finally, described herein is a message handling method for telecommunication terminal, the messages being received by the terminal during the use of an electronic messaging service. in the method includes analysing the messages to detect the message type to which each received message belongs amongst a set of predetermined message types capable of transporting data intended for software applications onboard the terminal and of extracting, from each received message (M) that belongs to one of the said messages types, the data intended for the said applications.

### BRIEF DESCRIPTION OF THE DRAWINGS

Other aims, features and advantages of the invention will appear on reading the following description, given only as a non-limiting example, and made with reference to the appended drawings in which:

FIG. 1 is a block diagram illustrating the architecture of a message-handling device for telephone terminal;

FIG. 2 is a table illustrating the disposition of the memorization means of the message analyser;

FIG. 3 is a table illustrating the disposition of the memorization means of the data extraction means;

FIG. 4 is a diagram illustrating the architecture of the data storage means in which the data extracted from the messages are loaded;

FIG. 5 is a flowchart illustrating the operation of a message handling device; and

FIG. 6 is a view of a standby screen of a telecommunication terminal illustrating an exemplary application of a message-handling device.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

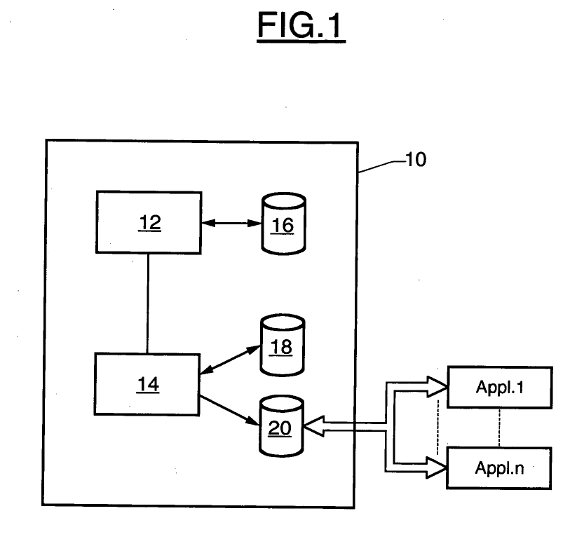

FIG. 1 shows the general structure of a message handling device, identified by the general reference number 10. This device 10 is intended to be integrated into a telecommunication terminal, such as a mobile telephone, to handle messages received during the use of electronic messaging services, such as the messaging services of the SMS, EMS, MMS types or also of electronic mail services for extracting received messages from the data intended to be used by the software applications Appl.1, . . . , Appl.n onboard the terminal.

As is shown in FIG. 1, the handling device 10 includes a message analyser 12 intended to receive the messages received by the device 10 and to detect the message type to which the message belongs and data extraction means 14 intended to extract the data intended for the software applications Appl.1, . . . , Appl.n.

Although in this FIG. 1 the modules 12 and 14 are represented in the form of distinct software bricks, it is nevertheless understood that these modules may be integrated into a single software brick integrated into the telecommunication terminal to which the device 10 belongs.

The analysis module 12 is associated with memorization means 16 in which is stored, for each type of message capable of being received, a set of selection criteria serving to identify the received message.

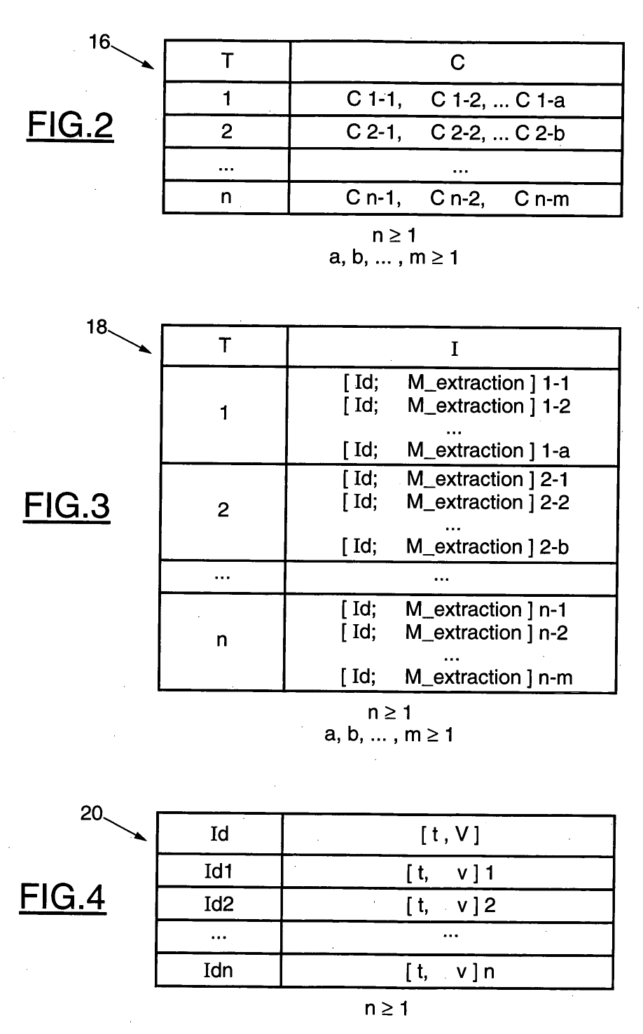

As is shown in FIG. 2, which illustrates the architecture of these memorization means 16, this information is stored in the form of a table containing, for each type T of messages 1, 2, . . . , n, a set of criteria C1-1, . . . , Cl-a; C2-1, . . . , C2-b, . . . , Cn-1, . . . Cn-m, where n is equal to or greater than 1 and a, b, . . . m, are equal to or greater than 1.

As will be described in detail hereafter, these selection criteria C are intended to be applied to the received message to recognize whether or not the message belongs to a known message type and to recognize the message type to which it belongs, amongst the set of message types 1, 2, . . . , n, which are capable of transporting data intended for the applications Appl. 1, . . . , Appl.n.

FIG. 1 shows that the data extraction module 14 is associated with first memorization means 18 into which are loaded, for each message type, a set of at least one data identifier used to recognize the type of data transported by the message and, for each type of identified data, to assign a corresponding extraction method.

As is seen in FIG. 3, these first memorization means 18 are laid out in the form of a table including, for each type T of messages 1, 2, . . . , n, information items I used for the extraction of the data. More particularly, in the first memorization means 18, each type T of messages 1, 2,. . . , n corresponds to one or more data identifiers Id and M_extraction information items indicating respective extraction methods to be applied to the messages.

The data extraction module 14 is also associated with second memorization means 20 used for the storage of the extracted data. With reference to FIG. 4, these extracted data are memorized in the form of a table combining, for each data identifier Id1, . . . Idn, a corresponding data type t and value v, this information then being directly accessible by the applications Appl.1, . . . , Appl.n.

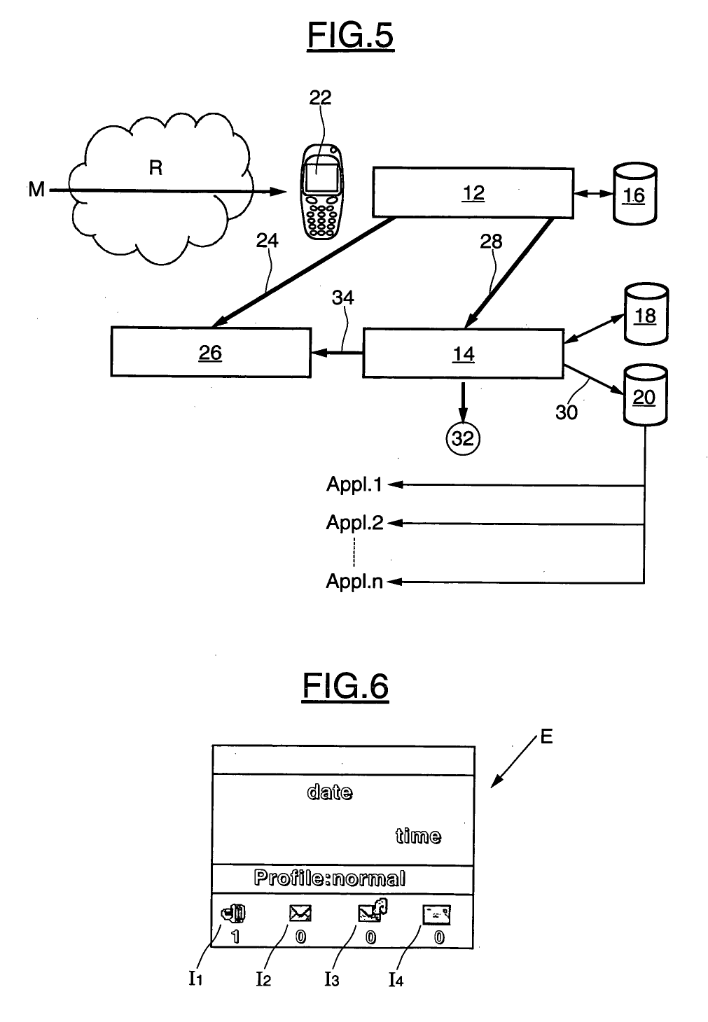

There now follows a description with reference to FIG. 5 of the principle of operation of the message-handling device that has just been described. In this figure, the main constituent elements of the device 10 have been depicted again, the arrows corresponding to operating steps of this device.

In operation, when the terminal receives a message M from the telecommunication network R to which the terminal 22 belongs, the user is at first not informed of the receipt of such a message. This message is in effect intercepted by the handling device which is installed in the terminal 22 and which carries out an analysis of this message in order to detect the possible presence of data intended for the applications Appl.1, . . . Appl.n. In order to carry out such an analysis, the message analysis module 12 applies the selection criteria C stored in the memorization means 16 in order to determine whether or not the received message M belongs to a message type known to be transporting such data and therefore in order to determine whether the message should be retained.

If the message is not recognized, that is to say if the message does not contain data intended for the software applications onboard the terminal 22, the message is handled in conventional manner (step 24) such that a graphic and/or audible notification is generated by means of an interface 26 in order to inform the user of the receipt of a new message.

On the other hand, if the message is recognized as containing pertinent data (step 28), the data that it contains are extracted by the data extraction module 14.

To carry out the analysis of a new message M, the analysis module 12 applies sequentially each of the criteria C to verify whether the new message is one of the n predetermined message types of which it has the description. When the analysis module 12 detects that the new message satisfies all the criteria of one of the message types T, the message and the message type are supplied to the data extraction module 14.

As previously indicated, to carry out the data extraction, this data extraction module 14 uses data identifiers Id in order to determine the type of data transported by the message, then assigns in consequence an extraction method to extract the transported data. Thus, at this stage, the extraction module detects, for example, whether the data are of text, image, sound, video, multimedia, etc. type and then carries out an extraction of these data according to the type of data detected. After extraction, the data are memorized in the second memorization means 20 in the form of information of type t and of value v of data associated with a data identifier Id (step 30).

When the data has been extracted, the message can be either deleted (step 32) or retained (step 34) in order to be handled in conventional manner, that is to say in order to be displayed on the interface 26 of the terminal 22.

As an illustrative, non-limiting example, a description will now be given of a particular example of use of the message handling method, in the case when the terminal 22 receives an SMS message notifying a new voice message in its voice mailbox.

When a caller leaves a voice message on the voicemail of the terminal 22, a class 0 SMS message containing a text message of the type “1 new message on your voicemail” is sent to the terminal 22. This message belongs to a message type known to the handling device of the terminal 22, that is the “SMS notifying of at least one voice message” type, carrying for example the number “1 ” with reference to FIGS. 2 and 3. The criteria for selecting this type of message are stored in the memorization means 16 and a set of at least one identifier of data to be extracted and one method of extracting these data are memorized in the memorization means 18. In the prior art, this SMS message was displayed, as received, on the screen of the terminal 22. According to an embodiment, the following handling method is applied to it:

The analyser 12 of the handling device installed in the terminal 22 intercepts the SMS message notifying of a voice message and analyses it in order to determine whether the message belongs to a known message type. The analysis includes detecting whether the message complies with one of the sets of selection criteria C, associated with one of the known message types stored in the memorization means 16. In this instance, the analyser detects that:
the address of the sender of the message is the address of the voicemail (criterion C1-1)
the class of the message is class 0 (criterion C1-2)
the text of the message is in the form “x new message(s) on your voicemail” (criterion C1-3).

The three criteria of the message type “1” being verified, the analyser 12 detects that it is a type “1” message, in other words an SMS message giving notice of at least one voice message.

The memorization means 18 memorize that the message type “1”:
contains the number of messages waiting in the voicemail, and
an extraction method capable of extracting either the first character of the message if the number of messages is equal to or less than 9, or the first two characters of the messages if the number of messages is equal to or greater than 10.

Using this information, the extraction module 14 extracts from the SMS message received the number of messages waiting in the voicemail, here one, and memorizes this number in the memorization means 20.

The handling device then updates the standby screen of the terminal 22 in order to show on it, in graphic manner, an indication according to which a new voice message is waiting in the voice mailbox of the user, here with the aid of an icon I1 (FIG. 6). The SMS notifying of a received voice message is here deleted before being displayed on the screen of the terminal 22, such that the user of the terminal 22 does not see it.

It will be noted that the invention is not limited to the embodiment described. Specifically, in the exemplary embodiment previously described, the message analysis module 12 essentially uses proprietary mechanisms, that is to say a set of selection criteria serving to identify the message type to which a received message belongs, by application of these criteria. As a variant, according to a mode of use of the messaging service by which the messages are sent in an extensible markup language, XML, the analysis module 12 may consist of an XML syntax analyser capable of detecting and identifying the markups contained in the XML message in order to detect the message type.

Likewise, the telecommunication terminal into which the handling device according to the invention is integrated may consist of any type of telecommunication terminal appropriate for the envisaged use, such as a telephone terminal of fixed or mobile type.

It will also be noted that a particularly valuable application of such a device concerns the creation and updating of a standby screen capable of representing in real time information useful to the user, such as the number of calls received, of calls sent, of calls lost, of SMS messages received, of MMS messages downloaded, the number of MMS messages awaiting downloading, the number of emails received, the number of voicemails waiting to be heard, etc.

To generate and update such a display, the analysis device 10 permanently intercepts the received messages in order to extract the voicemail notification messages. Such messages are identified with the aid of the selection criteria C loaded into the memorization means 16. For example, these criteria are chosen in order to verify the address of the sender of the message, the address having to correspond to that of the voicemail, to verify the class of the message, the class of the message having to be class zero, and to verify the text of the message, the text having to be for example in the form “X new messages on your voicemail”.

A method of extracting the pertinent information is then extracted from the database 18. When the requirement is to extract the number of messages and make it available to an application onboard the terminal, this extraction method consists, in this instance, of extracting the first character of the received message, which corresponds to the number of messages waiting.

If the above three criteria are verified, the number of messages waiting in the mailbox is extracted with the aid of the retrieved extraction method. This information is stored in the second memorization means 20 in order subsequently to be supplied to an application Appl.1, . . . Appl.n in order to update the display.

As is seen in FIG. 6, it is then possible to create a standby screen E on the terminal screen 22 on which appear, in association with current date “date” and time “time” information, notification message icons I1, I2, I3 and I4 for each type of message. It is also possible, with the aid of such a device, to extract other information, such as information relating to the voice messages received, for example the number of the caller, the date and time of delivery of the message, the length of the message, etc., and information relating to the state of the voice mailbox of the user, for example the number of new messages, the number of messages saved, the space available in the voice mailbox, etc.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

1. Message handling device for telecommunication terminal wherein the terminal is configured to receive messages during the use of an electronic messaging service, comprising a message analyser suitable for detecting one type of message amongst a set of predetermined message types capable of transporting data intended for software applications onboard the terminal and data extraction means suitable for extracting, from each received message that belongs to one of the said message types, the data intended for the said applications.

2. Device according to claim 1, further comprising means of storing the data extracted from the messages by the extraction means.

3. Device according to claim 1, wherein the message analyser comprises memorization means in which is stored, for each message type of the set of message types, a set of at least one selection criterion intended to be applied to each message received by the terminal for the detection of the message type.

4. Device according to claim 1, wherein the received messages being written in extensible markup language, XML, the message analyser comprises an XML syntax analyser.

5. Device according to claim 1, wherein the data extraction means comprise memorization means in which is stored, for each message type, a set of at least one data identifier intended to recognize the type of data transported by the message, each data identifier being assigned a corresponding data extraction method.

6. Device according to claim 2, wherein the data storage means comprise, for each extracted data item identified by a data type, data type and data value information.

7. Telephone terminal, equipped with a message handling device wherein the message handling device comprises a message analyser suitable for detecting one type of message amongst a set of predetermined message types capable of transporting data intended for software applications onboard the terminal and data extraction means suitable for extracting, from each received message that belongs to one of the said message types, the data intended for the said applications.

8. Message handling method for telecommunication terminal, wherein the terminal is configured to receive messages during the use of an electronic messaging service, wherein the method comprises analyzing the messages to detect the message type to which each received message belongs amongst a set of predetermined message types capable of transporting data intended for software applications onboard the terminal and of extracting, from each received message that belongs to one of the said message types, the data intended for the said applications.
